(19) United States
(12) Patent Application Publication
(10) Pub. No.: US 2016/0350657 A1
(43) Pub. Date: Dec. 1, 2016

(54) Cross-Module Behavioral Validation

(71) Applicant: QUALCOMM Incorporated, San Diego, CA (US)

(72) Inventors: Rajarshi Gupta, Sunnyvale, CA (US); Satyajit Prabhakar Patne, San Diego, CA (US); Suresh Bollapragada, San Diego, CA (US)

(21) Appl. No.: 14/726,855

(22) Filed: Jun. 1, 2015

(51) Int. Cl. G06N 5/04

(52) U.S. Cl. CPC G06N 5/04

(57) ABSTRACT

Systems, methods, and devices of the various aspects enable method of cross-module behavioral validation. A plurality of observer modules of a system may observe behavior or behaviors of a observed module of the system. Each of the observer modules may generate a behavior representation based on the behavior or behaviors of the observed module. Each observer module may apply the behavior representation to a behavior classifier model suitable for each observer module. The observer modules may aggregate classifications of behaviors of the observed module determined by each of the observer modules. The observer modules may determine, based on the aggregated classification, whether the observed module is behaving anomalously.

### BACKGROUND

The proliferation of portable electronics, computing devices, and communication devices has radically altered the environment in which people live, work, and play. Portable devices now offer a wide array of features and services that provide their users with unprecedented levels of access to information, resources, and communications. Commonly used tools, such as vehicles and appliances, increasingly include embedded or integrated electronic systems. Further, electronic devices are increasingly relied on to perform important tasks, such as monitoring the physical security of locations, the condition of patients, the safety of children, and the physical condition of machinery, to store and process sensitive information (e.g., credit card information, contacts, etc.), and to accomplish tasks for which security is important (e.g., to purchase goods, send and receive sensitive communications, pay bills, manage bank accounts, and conduct other sensitive transactions).

Electronic devices and appliances have thus evolved into complex electronic systems, and now commonly include several powerful processors, large memories, and other resources that allow for executing complex software applications. These complex electronic systems may include multiple modules or components, each provided with one or more processing modules to perform various tasks both alone and in combination with other system components. Due to the increasing importance of such electronic systems, maintaining system integrity against malfunctions and malicious attacks is of increasing importance.

### SUMMARY

Systems, methods, and devices of various embodiments enable one or more computing devices to perform cross-module behavioral validation. Various aspects may include observing, by a plurality of observer modules of a system, a behavior (i.e., one or more behaviors) of an observed module of the system, generating, by each of the observer modules, a behavior representation based on the behavior of the observed module, applying, by each of the observer modules, the behavior representation to a behavior classifier model for the observed module, aggregating, by each of the observer modules, classifications of behaviors of the observed module determined by each of the observer modules to generate an aggregated classification, and determining, based on the aggregated classification, whether the observed module is behaving anomalously.

In some aspects, each of the observer modules may observe different behaviors of the observed module. In some aspects, aggregating, by the observer modules, classifications of behaviors of the observed module determined by each of the observer modules may include weighting the classifications from each of the observer modules based on a perspective of each observer module on the behaviors of the observed module.

In some aspects, the perspective of each observer module on the behaviors of the observed module may include a number of behaviors of the observed module observed by each of the observer modules. In some aspects, the perspective of each observer module on the behaviors of the observed module may include one or more types of behaviors of the observed module observed by each of the observer modules. In some aspects, the perspective of each observer module on the behaviors of the observed module may include a duration of observation of the behaviors of the observed module by each of the observer modules. In some aspects, the perspective of each observer module on the behaviors of the observer module may include a complexity of observation of the behaviors of the observed module by each of the observer modules.

Some aspects may further include taking an action, by each of the observer modules, in response to determining that the observed module is behaving anomalously. In some aspects, taking an action, by each of the observer modules, in response to determining that the observed module is behaving anomalously may include taking an action by each of the observer modules based on the respective behaviors observed by each of the observer modules. In some aspects, taking an action, by each of the observer modules, may be based on one or more of a number of behaviors of the observed module observed by each of the observer modules, one or more types of behaviors of the observed module observed by each of the observer modules, a duration of observation of the behaviors of the observed module by each of the observer modules, and a complexity of observation of the behaviors of the observed module by each of the observer modules.

In some aspects, generating, by each of the observer modules, a behavior representation based on the behavior of the observed module may include generating, by each of the observer modules, a behavior vector based on the behavior of the observed module, and applying, by each of the observer modules, the behavior representation to a behavior classifier model for the observed module may include applying, by each of the observer modules, the behavior vector to a behavior classifier model for the observed module.

Various aspects may include a computing device including a processor configured with processor-executable instructions to perform operations of the embodiment methods described above. Various aspects may include a non-transitory processor-readable storage medium having stored thereon processor-executable software instructions configured to cause a processor to perform operations of the embodiment methods described above. Various aspects may include a processor within a system (e.g., a computing device system or a system of computing devices) that includes means for performing functions of the operations of the embodiment methods described above.

### BRIEF DESCRIPTION OF THE DRAWINGS

The accompanying drawings, which are incorporated herein and constitute part of this specification, illustrate exemplary aspects, and together with the general description given above and the detailed description given below, serve to explain the features of the various aspects.

FIG. 1A is an architectural diagram of an example system-on-chip suitable for implementing the various aspects.

FIG. 1B is a component block diagram illustrating logical components of a vehicular system suitable for implementing the various aspects.

FIG. 1C is a component block diagram illustrating logical components of an unmanned aircraft system suitable for implementing the various aspects.

FIG. 2 is a block diagram illustrating example logical components and information flows in a behavior characterization system that may be used to implement the various aspects.

FIG. 3 is a process flow diagram illustrating an aspect method for cross-module behavioral validation.

FIG. 4 is a process flow diagram illustrating an aspect method for cross-module behavioral validation.

FIG. 5 is a component block diagram of an example mobile device suitable for use with various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the various aspects or the claims.

The various aspects include methods, and computing devices and systems configured to implement the methods, of continuously monitoring and analyzing behavior of a plurality of computing modules (e.g., processors, SoCs, computing devices) connected together via various communication links in a system by each module monitoring each other module in the system, sharing the results and/or conclusions with the other modules in the system, and determining a behavioral anomaly in an observed module based on a combination of the observations and analyses of each of the modules. The various aspects may be implemented in any system that includes a number of programmable processors that communicate with one another. Such processors may be general processors, such as application processors, and specialized processors, such as modem processors, digital signal processors (DSPs), and graphics processors within a mobile communication device. The various aspects may also be implemented within systems of systems, such as among the various computing devices and dedicated processors within an automobile. For ease of descriptions, the various types of computing devices and processors implementing various aspects are referred to generally as “modules.” Further, the term “observing module” is used to refer to a module performing is monitoring operations, and the term “observed module” is used to refer to a module being observed. Since most or all modules observe most or all other modules in a computing system, any module in the system may be both an observing module and an observed module.

The terms “computing device” and “mobile device” are used interchangeably herein to refer to any one or all of cellular telephones, smartphones, personal or mobile multi-media players, personal data assistants (PDAs), laptop computers, tablet computers, smartbooks, ultrabooks, palmtop computers, wireless electronic mail receivers, multimedia Internet enabled cellular telephones, wireless gaming controllers, and similar personal electronic devices which include a memory, a programmable processor, and RF sensors.

The terms “component,” “system” and the like are used herein to refer to a computer-related entity, such as, but not limited to, hardware, firmware, a combination of hardware and software, software, or software in execution, which are configured to perform particular operations or functions. A module For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

A system may include a plurality of modules. For example, a system may include an application processor (AP), a modem processor, a graphics processing unit (GPU), and a digital signal processor (DSP), each considered a module. Each module may interact with each other module (e.g., over a communication bus), and each module may independently observe and analyze the behaviors of each other module. Thus as described above, each module may be both an “observer module” and an “observed module.” In other words, each module may function as a component of a behavioral analysis system.

The interactions of each module with the others may include different quantities and qualities of interaction. Each module (e.g., an AP, a GPU, and a DSP) may be tasked with performing a different function in a system and/or based on an application running on such system. For example, the AP may interact differently with the GPU and the DSP, while the GPU and the DSP may interact in a limited manner. Thus, the AP, GPU, and the DSP may each observe different behaviors of the other two modules. Different observer modules may therefore observe at least some different behaviors from an observed module. The behaviors observed by each observer module may also overlap at least in part.

Each observer module may analyze its observations and independently generate an analysis result of an observed module. The independent analyses of the observed module may be combined in each module (e.g., independently by each observer module), and based on the combined observations, the system or each module independently may determine whether a particular module is behaving anomalously (e.g., is malfunctioning, or has been compromised by malware).

In some aspects, each observer module may share with the other observer modules a determination that an observed module is behaving anomalously. Thus, each of the modules functioning as observer modules working together may act as an ensemble classifier of each of the modules in the computing system.

A determination that the observed module is behaving anomalously may be made based on a weighted average of the observations of each of the other modules (observer modules). Such a weighted average may be compared to a threshold to determine whether the combined observations rise to the level of anomalous behavior. As an example, the weight assigned to each module's conclusions may depend upon the degree of interaction between the observer module and the observed module. The degree of interaction may include a quantity of interactions and/or a type of interactions. Thus, for example, a modem processor's observations of a GPU may be weighted lower because the modem processor and the GPU interact infrequently (e.g., in a particular system, or as instructed by particular application), but the modem's observations of the DSP (i.e., in the same system and/or application) may be weighted higher if the modem processor and DSP interact regularly. Alternatively or in addition, a determination that the observed module is behaving anomalously may be made based on votes of each of the modules observing the observed module (i.e., observer modules), and the aggregate votes of each of the observer modules may yield an ensemble classification.

In some aspects, a model of each observed module may be loaded into or provided to each observer module. In other words, each module in a system may be provisioned with behavior analysis models that may be uniquely configured for each other module within the system. Each observer module may then adapt, adjust, or customize its model of the observed module based on the features of the model that characterize the observer module's interactions with the observed module. Each observer module may also independently analyze the observed module based on the observer module's interactions with the observed module. Again, since each module may observe every other module in a system, the references here to one observer module observing another observed module is intended to describe just one of the many observer/observed relationships in a system implementing an aspect.

In some aspects, when the behavioral analysis system implemented within the various modules determines that a module is behaving anomalously, each observer module may take a different action based on each observer module's interaction with that module. For example, the modem processor may restrict access by the AP to functions of the modem, while the GPU may display an alert that the AP is behaving anomalously. As another example, the modem processor may not take any actions with respect to a GPU determined to be behaving anomalously while the AP may limit most if not all interactions with the GPU.

Each module may be configured with a behavioral analysis function that may include a behavior observer module and a behavior analyzer module. The behavior observer module may be configured to observe behaviors of an interactions with other modules (e.g., messaging, instructions, memory accesses, requests, data transformations, and other module behavior) in order to monitor the behavior (e.g., activities, conditions, operations, and events) of each observed module (e.g., observed module events, state changes, etc.). The behavior observer module may collect behavior information pertaining to the observed module and may store the collected information in a memory (e.g., in a log file, etc.) in the form of behavior representations, which in some aspects may be behavior vectors. In the various aspects, the analyzer module may compare the generated behavior representations to one or more classifier models to evaluate the behavior of the observed module, to characterize the observed module behaviors, and to determine whether the observed module behaviors indicate that the observed module is behaving anomalously.

Each behavior representation may be a data structure or an information structure that includes or encapsulates one or more features. In some aspects, the behavior representation may be a behavior vector. A behavior vector may include an abstract number or symbol that represents all or a portion of observed module behavior that is observed by an observing module (i.e., a feature). Each feature may be associated with a data type that identifies a range of possible values, operations that may be performed on those values, the meanings of the values, and other similar information. The data type may be used by the observing module to determine how the corresponding feature (or feature value) should be measured, analyzed, weighted, or used.

In aspects in which the behavior representation is a behavior vector, the observer module may be configured to generate a behavior vector of size “n” that maps the observer real-time data into an n-dimensional space. Each number or symbol in the behavior vector (i.e., each of the “n” values stored by the vector) may represent the value of a feature. The observer module may analyze the behavior vector (e.g., by applying the behavior vector to a model of various observed modules to evaluate the behavior of each observed module. In some aspects, the observer module may also combine or aggregate the behavior scores of all observed behavior, for example, into an average behavior score, a weighted average behavior score, or another aggregation. In some aspects, one or more weights may be selected based on a feature of observed behavior.

In an aspect, the observer module may be configured to store models of observed modules. A model of an observed module may identify one or more features of observable behavior of the observed module that may indicate the observed module is behaving anomalously. In some aspects, models of observed module behavior may be stored in a cloud server or network, shared across modules of a large number of devices, sent to each observing module periodically or on demand, and customized in the observing module based on the observed behaviors of the observed module. One or more models of observed module behavior may be, or may be included, in a classifier model. In some aspects, the behavioral analysis system may adjust the size of a behavior vector to change the granularity of features extracted from the observed module behavior.

A classifier model may be a behavior model that includes data, entries, decision nodes, decision criteria, and/or information structures that may be used by a device processor to quickly and efficiently test or evaluate features (e.g., specific factors, data points, entries, APIs, states, conditions, behaviors, software applications, processes, operations, and/or components, etc.) of the observed real-time data. A classifier model may include a larger or smaller data set, the size of which may affect an amount of processing required to apply a behavior representation to the classifier model. For example, a “full” classifier model may be a large and robust data model that may be generated as a function of a large training dataset, and which may include, for example, thousands of features and billions of entries. As another example, a “lean” classifier model may be a more focused data model that is generated from a reduced dataset that includes or prioritizes tests on the features/entries that are most relevant for determining and characterizing the behavior of a particular observed module. In some aspects, the behavioral analysis system may change the robustness and/or size of a classifier model used to analyze a behavior representation.

A local classifier model may be a lean classifier model that is generated in an observer module. By generating classifier models in the observer module in which the models are used, the various aspects allow each observing module to accurately identify the specific features that are most important in determining and characterizing a particular observed module's behavior the particular behaviors that are observable by a particular observing module. These aspects also allow each observing module to accurately prioritize the features in the classifier models in accordance with their relative importance to classifying behaviors of the observed module.

Based on the comparison of the generated behavior representations to the one or more classifier models, the behavioral analysis system of each observer module may initiate an action. In some aspects, the action of each observer module may be different depending on the quantity and/or quality of the interaction between the observer module and the observed module.

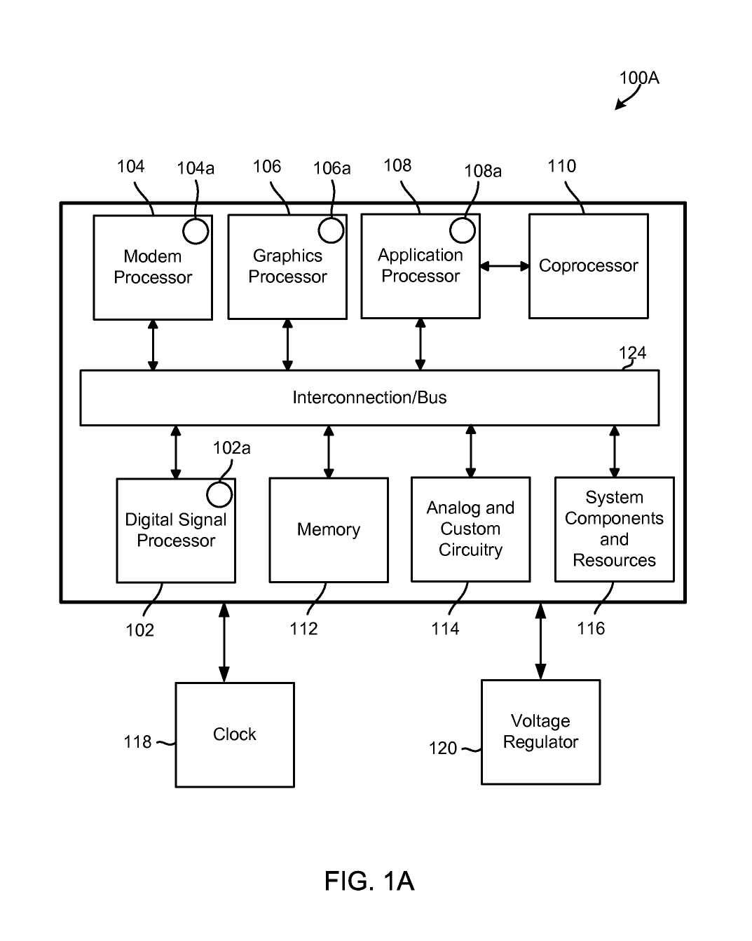

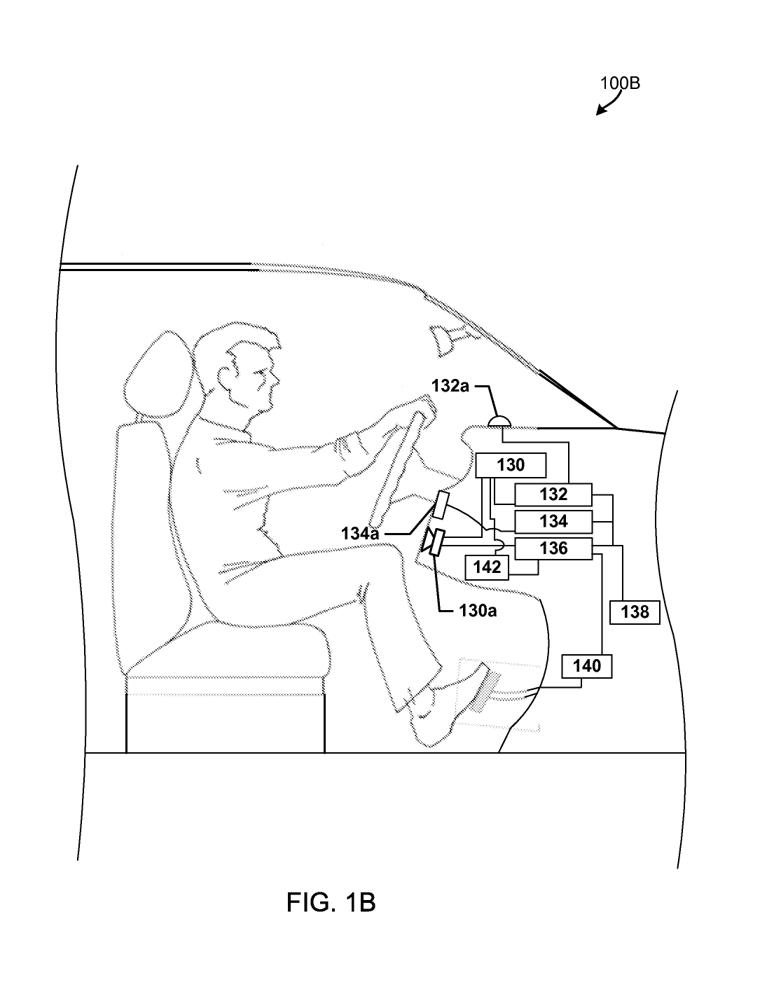

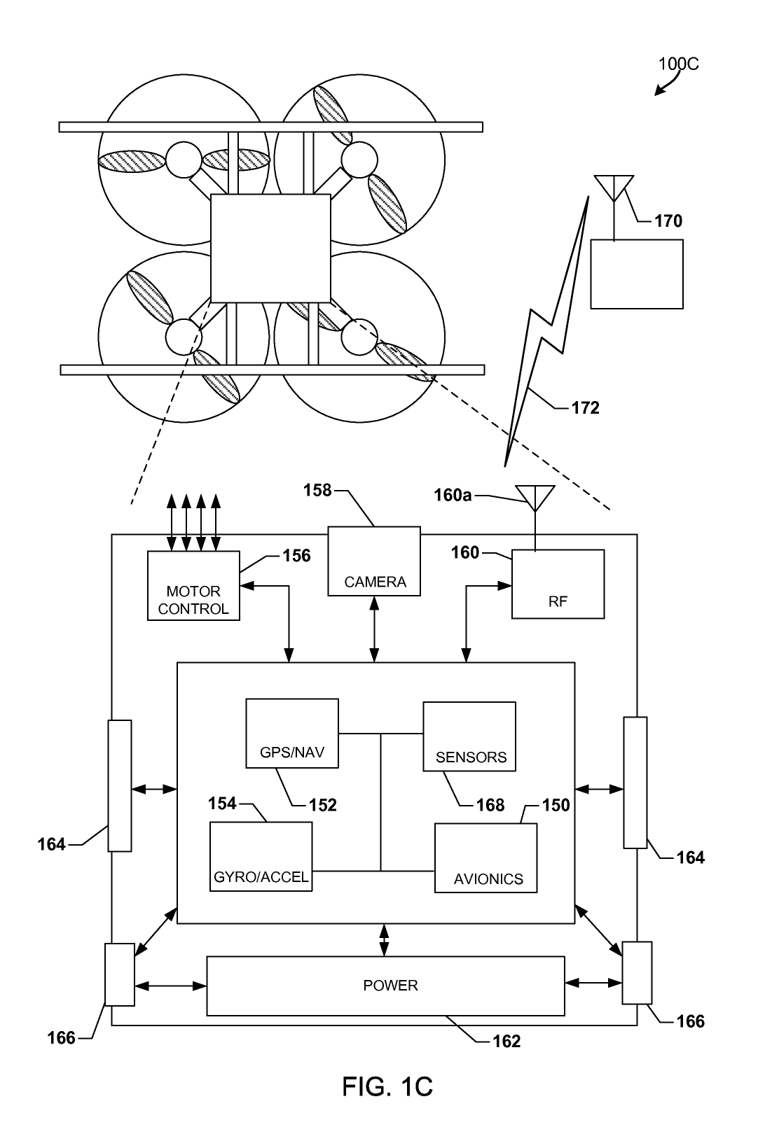

The various aspects may be implemented in a number of different computing devices, including single processor and multiprocessor systems, and a system-on-chip (SOC). FIG. 1A is an architectural diagram illustrating an example SOC 100A architecture that may be used in computing devices and systems implementing the various aspects. The SOC 100A may include a number of heterogeneous processors, such as a digital signal processor (DSP) 102, a modem processor 104, a graphics processor 106, and an application processor 108. The SOC 100A may also include one or more coprocessors 110 (e.g., vector co-processor) connected to one or more of the heterogeneous processors 102, 104, 106, 108. Each processor 102, 104, 106, 108, 110 may include one or more cores, and each processor/core may perform operations independent of the other processors/cores. For example, the SOC 100A may include a processor that executes a first type of operating system (e.g., FreeBSD, LINUX, OS X, etc.) and a processor that executes a second type of operating system (e.g., Microsoft Windows 8).

Each processor 102, 104, 106, 108, 110 may include or be provided with a small software application 102a, 104a,106a, 108a that may be configured to observe behaviors of the other processors and to independently generate an analysis result of each observed other processor. Each processor may interact with each other processor (e.g., over a communication bus 124), and each processor may independently observe and analyze the behaviors of each other processor.

The SOC 100A may also include analog circuitry and custom circuitry 114 for managing sensor data, analog-to-digital conversions, wireless data transmissions, and for performing other specialized operations, such as processing encoded audio signals for games and movies. The SOC 100A may further include system components and resources 116, such as voltage regulators, oscillators, phase-locked loops, peripheral bridges, data controllers, memory controllers, system controllers, access ports, timers, and other similar components used to support the processors and clients running on a computing device. The system components 116 and custom circuitry 114 may include circuitry to interface with peripheral devices, such as cameras, electronic displays, wireless communication devices, external memory chips, etc. The processors 102, 104, 106, and 108 may be interconnected to one or more memory elements 112, system components, and resources 116 and custom circuitry 114 via an interconnection/bus module 124, which may include an array of reconfigurable logic gates and/or implement a bus architecture (e.g., CoreConnect, AMBA, etc.). Communications may be provided by advanced interconnects, such as high performance networks-on chip (NoCs).

The SOC 100A may further include an input/output module (not illustrated) for communicating with resources external to the SOC, such as a clock 118 and a voltage regulator 120. Resources external to the SOC (e.g., clock 118, voltage regulator 120) may be shared by two or more of the internal SOC processors/cores (e.g., DSP 102, modem processor 104, graphics processor 106, applications processor 108, etc.).

The SOC 100A may also include hardware and/or software components suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth, WLAN, Wi-Fi, etc.), and other well-known components (e.g., accelerometer, etc.) of modern electronic devices.

In addition to the SOC 100A discussed above, the various aspects may be implemented in a wide variety of computing systems and systems of computing devices, which may include a single processor, multiple processors, multicore processors, or any combination thereof. For example, a vehicular system may include one or more electronic control units (ECUs).

FIG. 1B is a component block diagram of a manned vehicular system 100B. The vehicular system may include an infotainment system module 130, an environmental system module 132 (e.g., an air conditioning system), a navigation system module 134, a voice/data communications module 136, an engine control module 138, a pedal module 140, and transmission control module 142. The environmental system module 132 may communicate with an environment sensor 132a, which may provide information about environmental conditions within the vehicle. The infotainment system module 130 and the voice/data communications module 136 may communicate with a speaker/microphone 130a to receive and/or generate sound within the vehicle. The navigation system module 134 may communicate with a display 134a to display navigation information. The aforementioned modules are merely exemplary, and the behavior system may include one or more additional modules that are not illustrated for clarity. Such additional modules may include modules related additional other functions of the vehicular system, including instrumentation, airbags, cruise control, other engine systems, stability control parking systems, tire pressure monitoring, antilock braking, active suspension, battery level and/or management, and a variety of other modules. Each module 130-142 may communicate with one or more other modules via one or more communication links, which may include wired communication links (e.g., a Controller Area Network (CAN) protocol compliant bus, Universal Serial Bus (USB) connection, Firewire connection, etc.) and/or wireless communication links (e.g., a Wi-Fi® link, Bluetooth® link, ZigBee® link, ANT+® link, etc.).

Each module 130-142 may include at least one processor and at least one memory (not illustrated). The memory of each module may store processor-executable instructions and other data, including a software application that may be configured to observe behaviors of the other modules and to independently generate an analysis result of each observed other module. Each module may interact with each other processor (e.g., over a communication link), and each module may independently observe and analyze the behaviors of each other module.

As another example of a system in which the various aspects may also be implemented, FIG. 1C is a component block diagram of an unmanned aircraft system 100C. The unmanned aircraft system may include an avionics module 150, the GPS/NAV module 152, a gyro/accelerometer module 154, a motor control module 156, a camera module 158, and RF transceiver module 160, one or more payload modules 164, one or more landing sensor modules 166, and a sensor control module 168. The aforementioned modules 150-168 are merely exemplary, and the unmanned aircraft system may include a variety of additional or alternative modules. Each of modules 150-168 may communicate with one or more other modules via one or more communication links, which may include wired or wireless communication links.

The avionics module 150, the gyro/accelerometer module 154, and the GPS/NAV module may each be configured with processor-executable instructions to control flight operations and other operations of the unmanned aircraft system. The sensor module 168 may be configured with processor-executable instructions to receive input from one or more sensors, such as the camera module 158, landing sensor modules 166, and/or the payload modules 164. The motor control module 156 may receive information from and provide instructions to one or more motors of the unmanned aircraft system. The RF transceiver module 160 may communicate with an antenna 160a, to enable the unmanned aircraft system to communicate with a control system 170 via a wireless communication link 172. The payload modules 164 may receive information from and provide instructions to one or more payload modules that may be coupled to or provided to the unmanned aircraft system.

Each module 150-168 may include at least one processor and at least one memory (not illustrated) The memory of each module may store processor-executable instructions and other data, including a software application that may be configured to observe behaviors of the other modules and to independently generate an analysis result of each observed other module. Each module may interact with each other processor (e.g., over a communication link), and each module may independently observe and analyze the behaviors of each other module.

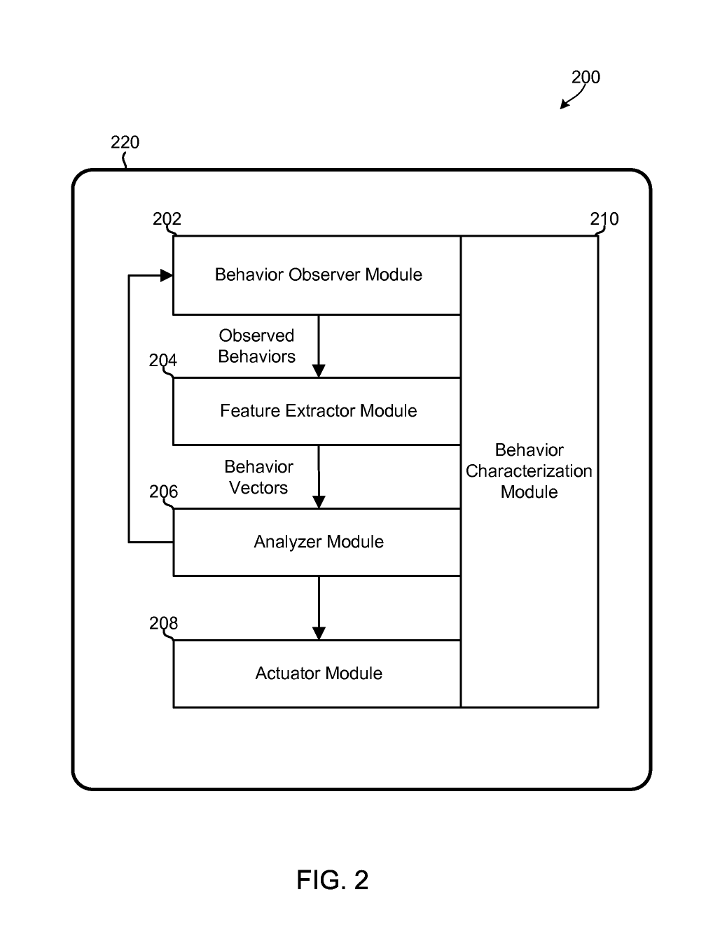

FIG. 2 illustrates example logical components and information flows in an aspect module 200 that includes a module behavior characterization system 220 configured to use behavioral analysis techniques to characterize behavior of an observed module in accordance with the various aspects. In the example illustrated in FIG. 2, the module includes a device processor (e.g., the processor 102a, 104a, 106a, 108a of FIG. 1A, or a processor of modules 130-142 of FIG. 1B, or a processor of modules 150-168 of FIG. 1C) configured with executable instruction modules that include a behavior observer module 202, a feature extractor module 204, an analyzer module 206, an actuator module 208, and a behavior characterization module 210.

In various aspects, all or portions of the behavior characterization module 210 may be implemented as part of the behavior observer module 202, the feature extractor module 204, the analyzer module 206, or the actuator module 208. Each of the modules 202-210 may be a thread, process, daemon, module, sub-system, or component that is implemented in software, hardware, or a combination thereof. In various aspects, the modules 202-210 may be implemented within parts of the operating system (e.g., within the kernel, in the kernel space, in the user space, etc.), within separate programs or applications, in specialized hardware buffers or processors, or any combination thereof. In an aspect, one or more of the modules 202-210 may be implemented as software instructions executing on one or more processors of the module 200.

The behavior characterization module 210 may be configured to characterize the behavior of an observed module, generate at least one behavior model based on the observed module's behavior, compare the observed behavior with a behavior model, aggregate the comparisons made by other observer modules of the behavior of the observed module and respective behavior models, and to determine, based on the aggregated comparisons, whether the observed module is behaving anomalously. The behavior characterization module 210 may use the information collected by the behavior observer module 202 to determine behaviors of the observed module, and to use any or all such information to characterize the behavior of the observed module.

The behavior observer module 202 may be configured to observe behaviors of the observed module based on messages, instructions, memory accesses, requests, data transformations, activities, conditions, operations, events, and other module behavior observed over a communication link between the observer module and the observed module.

To reduce the number of behavioral elements monitored to a manageable level, in an aspect, the behavior observer module 202 may be configured to perform coarse observations by monitoring or observing an initial set of behaviors or factors that are a small subset of all observable behaviors of the observed module. In some aspects, the behavior observer module 202 may receive the initial set of behaviors and/or factors from a server and/or a component in a cloud service or network. In some aspects, the initial set of behaviors/factors may be specified in machine learning classifier models.

The behavior observer module 202 may communicate (e.g., via a memory write operation, function call, etc.) the collected observed behavior data to the feature extractor module 204. The feature extractor module 204 may be configured to receive or retrieve the observed behavior data and use this information to generate one or more behavior representations. Each behavior representation may succinctly describe the observed behavior data in a value or vector data-structure. In some aspects in which the behavior representation is a behavior vector, the vector data-structure may include a series of numbers, each of which signifies a partial or complete representation of the real-time data collected by the behavior observer module 202.

In some aspects, the feature extractor module 204 may be configured to generate the behavior representations so that they function as an identifier that enables the behavioral analysis system (e.g., the analyzer module 206) to quickly recognize, identify, or analyze real-time sensor data of the device. In an aspect in which the behavior representation is a behavior vector, the feature extractor module 204 may be configured to generate behavior vectors of size “n,” each of which maps the real-time data of a sensor or hardware or software behavior into an n-dimensional space. In an aspect, the feature extractor module 204 may be configured to generate the behavior representations to include information that may be input to a feature/decision node in the behavior characterization module to generate an answer to a query regarding one or more features of the behavior data to characterize the behavior of the observed module.

The feature extractor module 204 may communicate (e.g., via a memory write operation, function call, etc.) the generated behavior representations to the analyzer module 206. The analyzer module 206 may be configured to apply the behavior representations to classifier modules to characterize the observed behaviors of the observed module, e.g., as within normal operating parameters, or as anomalous. In addition, the behavior analyzer module 206 may be configured to apply the behavior representations to classifier modules to characterize the behaviors of the observed module.

Each classifier model may be a behavior model that includes data and/or information structures (e.g., feature representations, behavior vectors, component lists, etc.) that may be used by an observing module (e.g., by a processor in an observing module) to evaluate a specific feature or aspect of the observed behavior data. Each classifier model may also include decision criteria for monitoring a number of features, factors, data points, entries, messages, instructions, memory calls, states, conditions, behaviors, processes, operations, components, etc. (herein collectively “features”) in the observed module. The classifier models may be preinstalled on the observer module, downloaded or received from a network server, generated in the observer module, or any combination thereof. The classifier models may be generated by using behavior modeling techniques, machine learning algorithms, or other methods of generating classifier models.

Each classifier model may be a full classifier model or a lean classifier model. A full classifier model may be a robust data model that is generated as a function of a large training dataset, which may include thousands of features and billions of entries. A lean classifier model may be a more focused data model that is generated from a reduced dataset that analyzes or tests only the features/entries that are most relevant for evaluating observed behavior data. A lean classifier model may be used to analyze a behavior representation that includes a subset of the total number of features and behaviors that could be observed in an observed module. As an example, a module may be may be configured to receive a full classifier model, generate a lean classifier model in the module based on the full classifier, and use the locally generated lean classifier model to evaluate observed module behavior data collected in a behavior representation.

A locally generated lean classifier model is a lean classifier model that is generated in a module. A different lean classifier model may be developed by each observer module in a system for each observed module, since each observer module may interact differently with, and thus observe different behaviors of, each observed module. Further, a different combination of features may be monitored and/or analyzed in each observer module in order for that module to quickly and efficiently evaluate the behavior of the observed module. The precise combination of features that require monitoring and analysis, and the relative priority or importance of each feature or feature combination, may often only be determined using information obtained from the specific observed module by the specific observer module. For these and other reasons, various aspects may generate classifier models in the mobile device in which the models are used.

Local classifier models may enable the device processor to accurately identify those specific features that are most important for evaluating the behavior of the observed module. The local classifier models may also allow the observer module to prioritize the features that are tested or evaluated in accordance with their relative importance to evaluating the behavior of the observed module.

In some aspects, classifier model specific to each observed module may be used, which is a classifier model that includes a focused data model that includes/tests only observed module-specific features/entries that are determined to be most relevant to evaluating the behavior of the observed module. By dynamically generating observed module-specific classifier models locally in the observer module, the various aspects allow the observer module to focus monitoring and analysis operations on a small number of features that are most important, applicable, and/or relevant for evaluating the behavior of the observed module.

In an aspect, the analyzer module 206 may be configured to adjust the granularity or level of detail of the features of the observed behavior that the analyzer module evaluates, in particular when an analysis of observed module behavior is inconclusive. For example, the analyzer module 206 may be configured to notify the behavior observer module 202 in response to determining that it cannot characterize a behavior of the observed module. In response, the behavior observer module 202 may change the factors or behaviors that are monitored and/or adjust the granularity of its observations (i.e., the level of detail and/or the frequency at which observed behavior is observed) based on a notification sent from the analyzer module 206 (e.g., a notification based on results of the analysis of the observed behavior features).

The behavior observer module may also observe new or additional behaviors, and send the new/additional observed behavior data to the feature extractor module 204 and the analyzer module 206 for further analysis/classification. Such feedback communications between the behavior observer module 202 and the analyzer module 206 may enable the module behavior characterization system 220 to recursively increase the granularity of the observations (i.e., make more detailed and/or more frequent observations) or change the real-time data that are observed until the analyzer module can evaluate and characterize behavior of an observed module to within a range of reliability or up to a threshold level of reliability. Such feedback communications may also enable the module behavior characterization system 220 to adjust or modify the behavior representations and classifier models without consuming an excessive amount of the observer module's processing, memory, or energy resources.

The observer module may use a full classifier model to generate a family of lean classifier models of varying levels of complexity (or “leanness”). The leanest family of lean classifier models (i.e., the lean classifier model based on the fewest number of test conditions) may be applied routinely until the analyzer module determines that it cannot reliably characterize the behavior of the observed module. In response to such determination, the analyzer module may provide feedback (e.g., a notification or instruction) to the behavior observer module and/or the feature extractor module to use ever more robust classifier models within the family of generated lean classifier models, until a definitive characterization of the observed module's behavior can be made by the analyzer module. In this manner, the module behavior characterization system 220 may strike a balance between efficiency and accuracy by limiting the use of the most complete, but resource-intensive classifier models to those situations where a robust classifier model is needed to definitively characterize the behavior of the observed module.

In various aspects, the observer module may be configured to generate lean classifier models by converting a representation or expression of observed behavior data included in a full classifier model into boosted decision stumps. The observer module may prune or cull the full set of boosted decision stumps based on specific features of the observed module's behavior to generate a lean classifier model that includes a subset of boosted decision stumps included in the full classifier model. The observer module may then use the lean classifier model to intelligently monitor and characterize the observed module's behavior.

Boosted decision stumps are one-level decision trees that may have exactly one node (i.e., one test question or test condition) and a weight value, and may be well suited for use in a light, non-processor intensive binary classification of data/behaviors. Applying a behavior representation to boosted decision stump may result in a binary answer (e.g., 1 or 0, yes or no, etc.). For example, a question/condition tested by a boosted decision stump may include whether a word or sound detected by a device microphone is characteristic of an RF-sensitive environment, or whether an image of another device captured by a device camera is recognizable as an RF emissions generating hazard, the answers to which may be binary. Boosted decision stumps are efficient because they do not require significant processing resources to generate the binary answer. Boosted decision stumps may also be highly parallelizable, and thus many stumps may be applied or tested in parallel/at the same time (e.g., by multiple cores or processors in a module, computing device, or system).

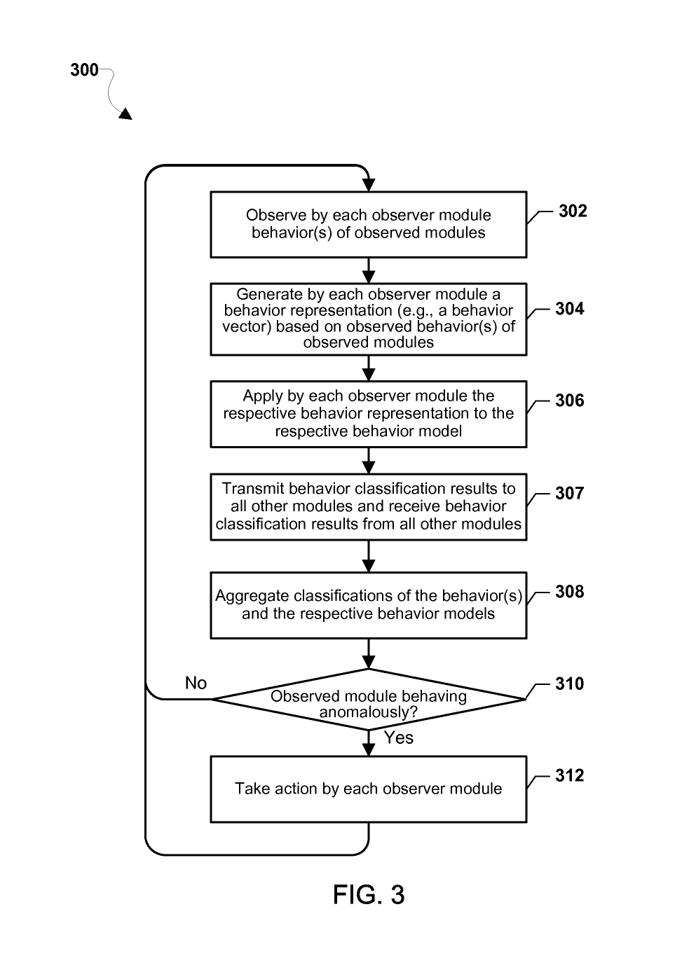

FIG. 3 illustrates a method 300 for cross-module behavioral validation in accordance with the various aspects. The method 300 may be performed by a processing core or device processor of a module, such as a processor on a system-on-chip (e.g., processors 101, 104, 106, and 108 on the SOC 100 illustrated in FIG. 1A) or any similar processor (e.g., a processor of modules 130-142 of FIG. 1B, or a processor of modules 150-168 of FIG. 1C), and may employ a behavioral analysis system to observe and characterize behaviors of an observed module (e.g., the module behavior characterization system 220 in FIG. 2).

In block 302, each observer module may observe the behavior or behaviors of an observed module. Each observer module may observe behavior(s) of a plurality of observed modules. Each observer module may have a different perspective on the behavior of the observed module, as each observer module may have different quantities and/or qualities of interactions with the observed module. Thus, different observer modules may observe different behaviors from the observed module. The behaviors observed by each of the observer modules may also overlap at least in part. The observed module's behavior may include or be based on one or more of messages, instructions, memory accesses, requests, data transformations, activities, conditions, operations, events, and other module behavior observed over a communication link between the observer module and the observed module.

In block 304, each observer module may generate a behavior representation characterizing the behavior or behaviors of the observed module that are observed by each observer module. Each observer module may generate behavior representations characterizing each of a plurality of observed modules. In some aspects the behavior representation may be a behavior vector. A behavior vector may be a sequence of values characterizing each of a number of behavior features.

In block 306, each observer module may apply the behavior representation (e.g., the behavior vector) characterizing behaviors of the observed module to the respective behavior classifier model of the observed module. By applying the behavior representation to the respective behavior classifier model of the observed module, each observer module may generate one or more behavior classifications of the behavior(s) of the observed module. In an aspect in which the behavior classifier model is an array of boosted decision stubs, this operation may involve using each value in the behavior representation to a respective decision stub to determine an outcome, and applying the weight associated with the outcome of each decision stub, and summing or otherwise arriving at an overall conclusion based upon all of the decision stubs to arrive at a classification of the behavior, such benign or non-benign.

As each module may be observing most or all other modules in the system, the operations of blocks 302-306 may be repeated and/or performed more or less at the same time for all of the modules that any one module is observing. Thus, the outcome of the operations of block 306 (i.e., a result or output) may be a classification of behaviors of each of the modules observed by a given module. For example, the GPU may maintain a continuously updated classification of behavior (e.g., “normal”, or “anomalous”) of the DSP and the modem processor.

In block 307, each of the modules may transmit their behavior classifications (i.e., behavior classification results) of all observed modules to all or most other modules in the system, and may receive behavior classification results of observed modules from all or most other modules in the system.

In block 308, the observer modules may aggregate the classifications of the behavior(s) of each module received from other modules and its own classification. In some aspects, the observer modules may aggregate their respective classifications at one or more of the observer modules. In some aspects, each observer module may receive the behavior classifications of each of the other observer modules. For example, an observed module (e.g., the GPU) may be observed by the other modules in the system or device (e.g., the AP, the modem processor, and the DSP). The AP, the modem processor, and the DSP may each provide their behavior classifications of the GPU's behavior(s) to each other, and to each of the AP, the modem processor, and the DSP may combine the analyses of the other observer modules. For example, the AP may receive the classifications performed by the modem processor and the DSP, and the modem processor may receive the classifications performed by the AP and the DSP, and the DSP may receive the classifications performed by the AP and the modem processor. Each observer module may combine the independent analyses. In some embodiments, the observer modules may aggregate the classifications of the behavior(s) of each module received from other modules and its own classification, and the respective behavior models of each module and its own. For example, each observer module may adjust and/or update its behavior model for an observed module based on the behavior model received from of one or more other observer modules.

In determination block 310, one or more of the modules may determine, based on the aggregated classifications, whether an observed module is behaving anomalously. In some aspects, each observer module may share with the other observer modules a determination that an observed module is behaving anomalously. Thus, each of the observer modules working together may act as an ensemble classifier of each of the observed modules. The determination that the observed module is behaving anomalously may be made based on a weighted average of the classifications of each of the observer modules. The weighted average may be compared to a threshold to determine whether the combined observations rise to the level of anomalous behavior. As an example, the weight assigned to each module's conclusions may depend upon the degree of interaction between the observer module and the observed module. The degree of interaction may include a quantity of interactions and/or a type of interactions. Thus, for example, a modem processor's observations of a GPU may be weighted lower because the modem processor and the GPU interact infrequently (e.g., in a particular system, or as instructed by particular application), but the modem's observations of the DSP (i.e., in the same system and/or application) may be weighted higher if the modem processor and DSP interact regularly. Alternatively, the determination that the observed module is behaving anomalously may be made based on votes of each of the observer modules, and the aggregate votes of each of the observer modules may yield an ensemble classification.

In response to determining that an observed module is not behaving anomalously (i.e., determination block 310=“No”), the modules may repeat the operations of blocks 302-310 in order to continuously monitor behaviors of modules within the system.

In response to determining that an observed module is behaving anomalously (i.e., determination block 310=“Yes”), each module may take an action in block 312. In some aspects, each module may take a different action based on the specific behaviors observed by each observer module, and or the particular details of each observer module's interactions with the observed module. As one example, the DSP 102, the modem processor 104, and the GPU 106 may each take different actions in response to determining (independently, or in an ensemble) that the AP 108 is behaving anomalously. In some aspect, each module may reduce or limit its interaction with a module that is behaving anomalously. A module may also refuse to perform instructions sent from a module that is behaving anomalously. Additionally, or alternatively, a module may limit or prevent access to its functions and/or memory addresses by the module that is behaving anomalously. For example, the DSP may not provide to the AP access to the DSP's memory addresses, or the DSP may refuse to process data sent by the AP. As another example, the modem processor may deny the AP access to external communications (e.g., via a modem). As another example, the GPU may not display or process visual or graphical data sent from the AP. As another example, the modem processor may not take any actions with respect to a GPU determined to be behaving anomalously while the AP may limit most if not all interactions with the GPU. As a further example, a module (e.g., the GPU or the AP) may instruct the display of a message to a user. As another example, the modem processor may send a message, such as a notification or an alert, to a server via a communication link, such as a notification to an enterprise server, or a notification to an email address or messaging address. The observer modules may observe behavior or behaviors of another observed module in block 302 and repeat the operations of blocks 302-312 as described above.

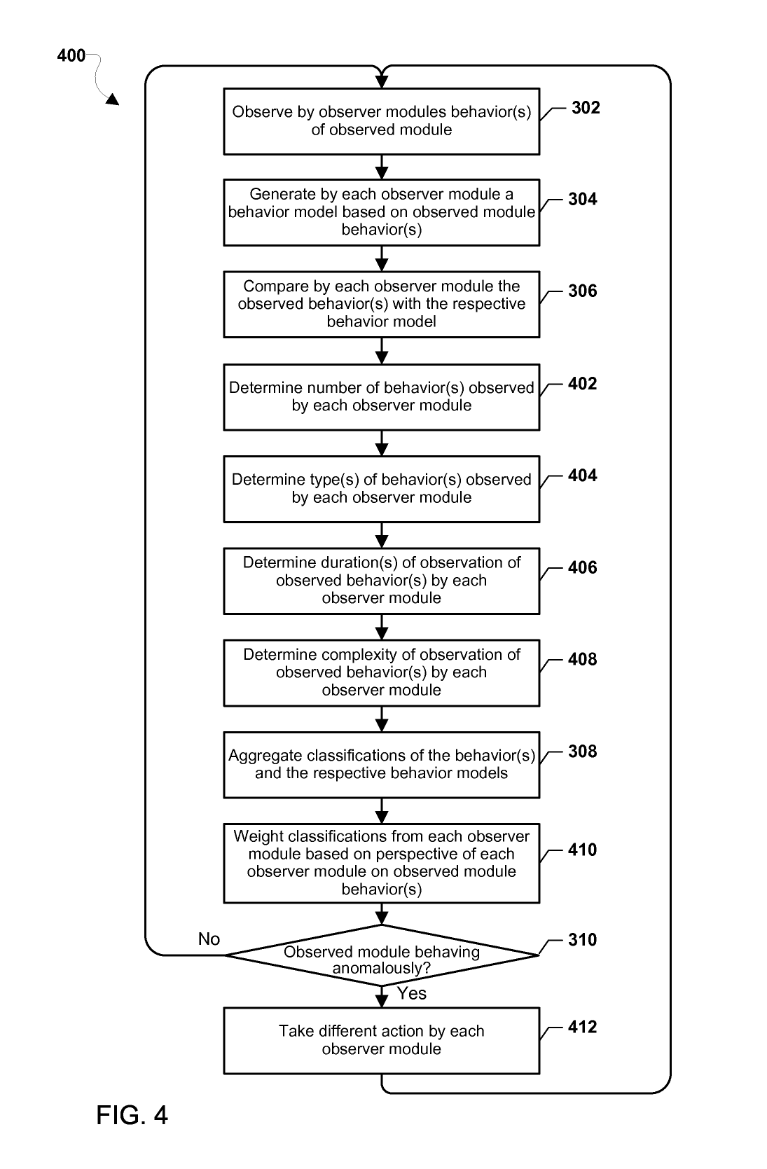

FIG. 4 illustrates a method 400 for cross-module behavioral validation in accordance with the various aspects in accordance with an aspect. The method 400 may be performed by a processing core or device processor of a module, such as a processor on a system-on-chip (e.g., processors 101, 104, 106, and 108 on the SOC 100 illustrated in FIG. 1A) or any similar processor (e.g., a processor of modules 130-142 of FIG. 1B, or a processor of modules 150-168 of FIG. 1C), and may employ a behavioral analysis system to observe and characterize behaviors of an observed module (e.g., the module behavior characterization system 220 in FIG. 2). In some aspects the device processor may perform operations in blocks 302-310 similar to those described with reference to blocks 302-310 of the method 300 (see FIG. 3).

In block 402, each observer module may determine a number of behavior(s) of the observed module that each observer module may observe. In block 404, each observer module may determine one or more types of behaviors of the observed module that each observer module observes.

In block 406, each observer module may determine a duration of observation of the observed module by each of the observer modules. In block 408, each observer module may determine a complexity of observations of the observed module by each of the observer modules. For example, each observer module and the observed module may send and/or receive instructions, messages, commands, information, memory address accesses, notifications, data, or other information that may vary in complexity, detail, length, amount of information, amount of processing required, or another form of complexity, as compared to the interactions of other observer modules and the observed module.

Each observer module may have a different perspective on the behavior of the observed module, as each observer module may have different quantities and/or qualities of interactions with the observed module. Thus, different observer modules may observe different behaviors from the observed module. Examples of types of observed behaviors may include one or more of messages, instructions, memory accesses, requests, data transformations, activities, conditions, operations, events, and other module behavior observed over a communication link between the observer module and the observed module.

In block 308, the observer modules may aggregate the classifications of the observed behavior or behaviors of the observed module to the respective behavior models. The observer modules may aggregate the classifications at one or more of the observer modules.

In block 410, the observer modules weight the classifications from each of the observer modules based on the perspective of each observer module on the behaviors of the observed module (i.e., the behavior or behaviors observed by each observer module). In some aspects, the weight of each observer module's classifications may be based on one or more of the determined number of behaviors of the observed module that each observer module observed, the determined one or more types of behaviors of the observed module that each observer module observed, and the determined duration of observation of the observed module by each of the observer modules. For example, less weight may be given to the classifications of a module that makes fewer observations of the observed module, observes minor or non-critical types of behaviors of the observed module, and/or observes behaviors of the observed module for a relatively short period of time. Conversely, more weight may be given to the classifications of a module that makes more observations, or observes critical types of behavior, or observes behavior for a relatively long period of time. For example, a GPU's observations of behaviors of a DSP may be weighted relatively lower due to the GPU's relatively limited number, type, duration, and/or complexity of interactions with the DSP, while an AP's observations of the DSP (or any other module) may be weighted relatively higher, because the AP typically interacts with all other modules, and further the AP typically may make a greater number, type, duration, and/or complexity of observations of the other modules.

In some aspects, the weight given to each observer module's classifications may be assigned after aggregating the classifications, and thus the assigned weights may be based on the relative qualities and quantities of each observer module's observations as compared to other observer modules.

In some aspects, the operations of block 410 may be performed before the operations of block 308, so that each observer module's classifications are given a weight based on the determined number of behaviors observed, the determined one or more types of behaviors observed, the determined duration of observation, and/or the determined complexity of observations of observed behavior(s) by each observer module prior to aggregating the comparisons of each of the observer modules.

In determination block 310, one or more of the observer modules may determine, based on the weighted aggregated classifications, whether the observed module is behaving anomalously. In response to determining that the observed module is not behaving anomalously (i.e., determination block 310=“No”), the observer modules may return to block 302 and the observer modules may repeat the operations of blocks 302-410.

In response to determining that the observed module is behaving anomalously (i.e., determination block 310=“Yes”), each observer module may take a different action in block 412. In some aspects, each observer module may take a different action based on the specific behaviors observed by each observer module, and or the particular details of each observer module's interactions with the observed module. In some aspects, the action that each observer module takes may be based on the determined number of behaviors observed, the determined one or more types of behaviors observed, and/or the determined duration of observation of each of the observer modules. Thus, the action that each observer module takes may include taking an action by each of the observer modules based on the respective behaviors observed by each of the observer modules. The observer modules may then return to block 302 and the observer modules may repeat the operations of blocks 302-410.

The various aspects improve upon existing solutions by using behavior analysis and/or machine learning techniques at each module of a system to monitor and evaluate the behavior of each other module in the system to determine whether an observed module is behaving anomalously. The use of behavior analysis or machine learning techniques by observer modules to evaluate the behavior of an observed module is important because current computing devices and electronic systems are extremely complex systems, and the behaviors of each observed module that are observable from the perspective of each observer module, as well as the features that are extractable from such behaviors, may be different in each computing device or system. Further, different combinations of observable behaviors/features/factors may require a different analysis in each device or system in order for that device to evaluate the behavior of an observed module. The precise combination of behaviors and/or features that an observer module monitors may, in some cases, be determined using information obtained from the specific observed module. For these and other reasons, existing solutions are not adequate for evaluating observed modules for anomalous behavior in a highly complex and diverse system or device, and without consuming a significant amount of the system's or device's processing, memory, and/or power resources.

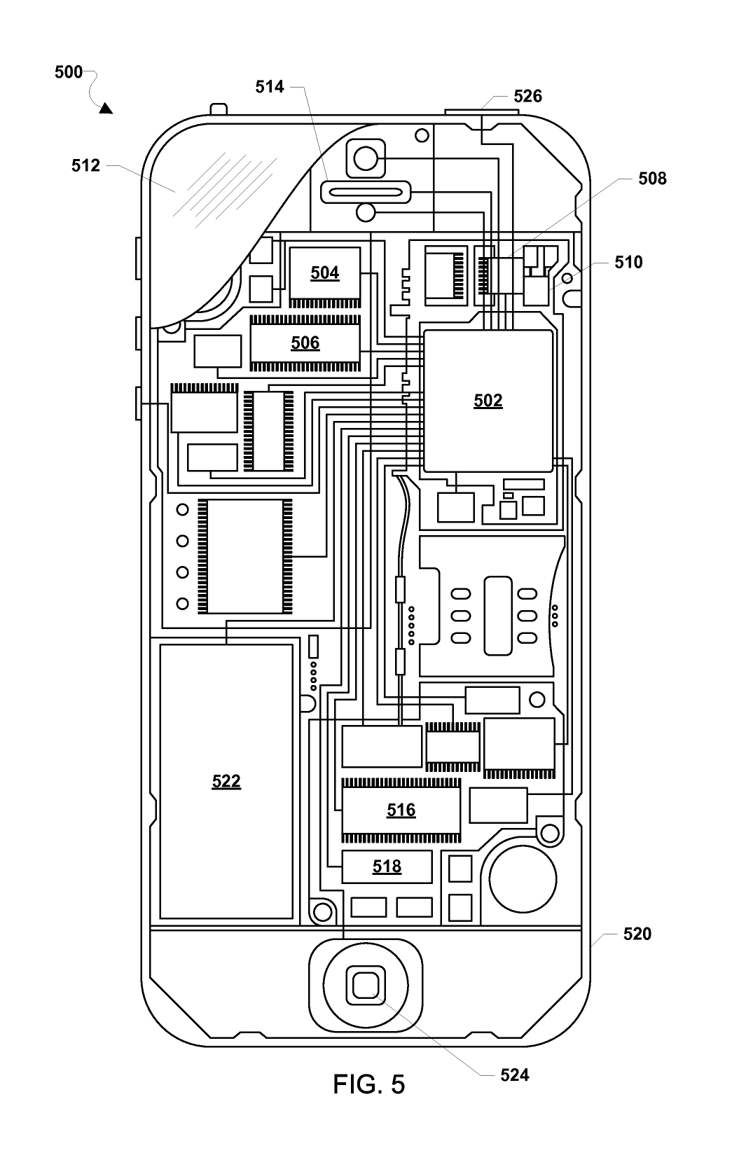

The various aspects, including the aspects discussed above with reference to FIGS. 1A-4, may be implemented on a variety of computing devices, an example of which is the mobile communication device 500 illustrated in FIG. 5. The mobile computing device 500 may include a processor 502 coupled to internal memory 504, a display 512, and to a speaker 514. The processor 502 may be one or more multi-core integrated circuits designated for general or specific processing tasks. The internal memory 504 may be volatile or non-volatile memory, and may also be secure and/or encrypted memory, or unsecure and/or unencrypted memory, or any combination thereof. The mobile communication device 500 may have two or more radio signal transceivers 508 (e.g., Peanut, Bluetooth, Zigbee, Wi-Fi, RF radio, etc.) and antennae 510 for sending and receiving communications, coupled to each other and to the processor 502. Additionally, the mobile communication device 500 may include an antenna 510 for sending and receiving electromagnetic radiation that may be connected to a wireless data link and/or transceiver 508 coupled to the processor 502. The mobile communication device 500 may include one or more cellular network wireless modem chip(s) 516 coupled to the processor 502 and antennae 510 that enables communications via two or more cellular networks via two or more radio access technologies.

The mobile communication device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown). The mobile communication device 500 may also include speakers 514 for providing audio outputs. The mobile communication device 500 may also include a housing 520, constructed of a plastic, metal, or a combination of materials, for containing all or some of the components discussed herein. The mobile communication device 500 may include a power source 522 coupled to the processor 502, such as a disposable or rechargeable battery. The rechargeable battery may also be coupled to the peripheral device connection port to receive a charging current from a source external to the mobile communication device 500. The mobile communication device 500 may also include a physical button 524 for receiving user inputs. The mobile communication device 500 may also include a power button 526 for turning the mobile communication device 500 on and off.

The processor 502 may be any programmable microprocessor, microcomputer or multiple processor chip or chips that can be configured by software instructions (applications) to perform a variety of functions, including the functions of various aspects described below. In some mobile communication devices, multiple processors 502 may be provided, such as one processor dedicated to wireless communication functions and one processor dedicated to running other applications. Typically, software applications may be stored in the internal memory 504 before they are accessed and loaded into the processor 502. The processor 502 may include internal memory sufficient to store the application software instructions. In various aspects, the processor 512 may be a device processor, processing core, or an SOC (such as the example SOC 100 illustrated in FIG. 1A). In an aspect, the mobile communication device 700 may include an SOC, and the processor 702 may be one of the processors included in the SOC (such as one of the processors 102, 104, 106, 108, and 110 illustrated in FIG. 1A).

Computer code or program code for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many mobile computing devices operating system kernels are organized into a user space (where non-privileged code runs) and a kernel space (where privileged code runs). This separation is of particular importance in Android® and other general public license (GPL) environments where code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples, and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various aspects.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the various aspects. Various modifications to these aspects will be readily apparent to those skilled in the art, and the generic principles defined herein may be applied to other aspects without departing from the spirit or scope of the various aspects. Thus, the various aspects are not intended to be limited to the aspects shown herein but are to be accorded the widest scope consistent with the following claims and the principles and novel features disclosed herein.

What is claimed is:

1. A method of cross-module behavioral validation, comprising:
observing, by a plurality of observer modules of a system, a behavior of an observed module of the system;
generating, by each of the observer modules, a behavior representation based on the behavior of the observed module;
applying, by each of the observer modules, the behavior representation to a behavior classifier model for the observed module;
aggregating, by each of the observer modules, classifications of behaviors of the observed module determined by each of the observer modules to generate an aggregated classification; and
determining, based on the aggregated classification, whether the observed module is behaving anomalously.

2. The method of claim 1, wherein each of the observer modules observe different behaviors of the behavior of the observed module.

3. The method of claim 1, wherein aggregating, by the observer modules, classifications of behaviors of the observed module determined by each of the observer modules comprises weighting classifications from each of the observer modules based on a perspective of each observer module on the behavior of the observed module.

4. The method of claim 3, wherein the perspective of each observer module on the behavior of the observed module comprises a number of behaviors of the observed module observed by each of the observer modules.

5. The method of claim 3, wherein the perspective of each observer module on the behavior of the observed module comprises one or more types of behaviors of the observed module observed by each of the observer modules.

6. The method of claim 3, wherein the perspective of each observer module on the behavior of the observed module comprises a duration of observation of the behavior of the observed module by each of the observer modules.

7. The method of claim 3, wherein the perspective of each observer module on the behavior of the observer module comprises a complexity of observation of the behavior of the observed module by each of the observer modules.

8. The method of claim 1, further comprising:
taking an action, by each of the observer modules, in response to determining that the observed module is behaving anomalously.

9. The method of claim 8, wherein taking an action, by each of the observer modules, in response to determining that the observed module is behaving anomalously comprises taking an action by each of the observer modules based on the respective behaviors observed by each of the observer modules.

10. The method of claim 9, wherein taking an action, by each of the observer modules, is based on one or more of a number of behaviors of the observed module observed by each of the observer modules, one or more types of behaviors of the observed module observed by each of the observer modules, a duration of observation of the behaviors of the observed module by each of the observer modules, and a complexity of observation of the behaviors of the observed module by each of the observer modules.

11. The method of claim 1, wherein:
generating, by each of the observer modules, a behavior representation based on the behavior of the observed module comprises generating, by each of the observer modules, a behavior vector based on the behavior of the observed module, and
applying, by each of the observer modules, the behavior representation to a behavior classifier model for the observed module comprises applying, by each of the observer modules, the behavior vector to a behavior classifier model for the observed module.

12. A computing device, comprising:
a processor configured with processor-executable instructions to perform operations comprising:
observing a behavior of an observed module of the computing device;
generating a behavior representation based on the behavior of the observed module;
applying the behavior representation to a behavior classifier model for the observed module;
aggregating classifications of behaviors of the observed module determined by the processor and each of a plurality of observer modules to generate an aggregated classification; and
determining whether the observed module is behaving anomalously.

13. The computing device of claim 12, wherein the processor is configured with processor-executable instructions to perform operations such that the computing device observes different behaviors of the observed module than behaviors observed by the plurality of observer modules.

14. The computing device of claim 12, wherein the processor is configured with processor-executable instructions to perform operations such that aggregating classifications of behaviors of the observed module determined by the processor and each of a plurality of observer modules comprises weighting classifications from the processor each of the observer modules based on a perspective of the processor and each observer module on the behavior of the observed module.

15. The computing device of claim 14, wherein the processor is configured with processor-executable instructions to perform operations such that the perspective of the processor and each observer module on the behavior of the observed module comprises a number of behaviors of the observed module observed by the processor and each of the observer modules.

16. The computing device of claim 14, wherein the processor is configured with processor-executable instructions to perform operations such that the perspective of the processor and each observer module on the behavior of the observed module comprises one or more types of behaviors of the observed module observed by the processor and each of the observer modules.

17. The computing device of claim 14, wherein the processor is configured with processor-executable instructions to perform operations such that the perspective of the processor and each observer module on the behavior of the observed module comprises a duration of observation of the behavior of the observed module by the processor and each of the observer modules.

18. The computing device of claim 14, wherein the processor is configured with processor-executable instructions to perform operations such that the perspective of the processor and each observer module on the behavior of the observer module comprises a complexity of observation of the behavior of the observed module by the processor and each of the observer modules.

19. The computing device of claim 12, wherein the processor is configured with processor-executable instructions to perform operations further comprising:
taking an action in response to determining that the observed module is behaving anomalously.

20. The computing device of claim 19, wherein the processor is configured with processor-executable instructions to perform operations such that taking an action in response to determining that the observed module is behaving anomalously comprises taking an action based on the observed behavior.

21. The computing device of claim 20, wherein the processor is configured with processor-executable instructions to perform operations such that taking an action based on the observed behavior is based on one or more of a number of behaviors of the observed module observed by each of the observer modules, one or more types of behaviors of the observed module observed by each of the observer modules, a duration of observation of the behavior of the observed module by each of the observer modules, and a complexity of observation of the behavior of the observed module by each of the observer modules.

22. The computing device of claim 12, wherein:
generating, by each of the observer modules, a behavior representation based on the behavior of the observed module comprises generating, by each of the observer modules, a behavior vector based on the behavior of the observed module, and
applying, by each of the observer modules, the behavior representation to a behavior classifier model for the observed module comprises applying, by each of the observer modules, the behavior vector to a behavior classifier model for the observed module.

23. A non-transitory processor-readable storage medium having stored thereon processor-executable software instructions configured to cause a processor within a system to perform operations cross-module behavioral validation, comprising:
observing a behavior of an observed module of the system;
generating a behavior representation based on the behavior of the observed module;
applying the behavior representation to a behavior classifier model for the observed module;
aggregating classifications of behaviors of the observed module determined by the processor and each of a plurality of observer modules to generate an aggregated classification; and
determining whether the observed module is behaving anomalously.

24. The non-transitory processor-readable storage medium of claim 23, wherein the stored processor-executable software instructions are configured to cause a processor to perform operations such that the processor observes a different behavior of the observed module than behaviors observed by the plurality of observer modules.

25. The non-transitory processor-readable storage medium of claim 23, wherein the stored processor-executable software instructions are configured to cause a processor to perform operations such that aggregating classifications of behaviors of the observed module determined by the processor and each of a plurality of observer modules comprises weighting classifications from the processor and each of the observer modules based on a perspective of the processor and each observer module on the behaviors of the observed module.

26. The non-transitory processor-readable storage medium of claim 25, wherein the processor is configured with processor-executable instructions to perform operations such that the perspective of the processor and each observer module on the behavior of the observed module comprises one or more of a number of behaviors of the observed module observed by the processor and each of the observer modules, one or more types of behaviors of the observed module observed by the processor and each of the observer modules, a duration of observation of the behavior of the observed module by the processor and each of the observer modules, and a complexity of observation of the behavior of the observed module by the processor and each of the observer modules.

27. A processor within a system, comprising:
means for observing a behavior of an observed module of the system;
means for generating a behavior representation based on the behavior of the observed module;
means for applying the behavior representation to a behavior classifier model for the observed module;
means for aggregating classifications of behaviors of the observed module determined by each of the processor and a plurality of observer modules within the system to generate an aggregated classification; and
means for determining whether the observed module is behaving anomalously.

28. The processor of claim 27, wherein the processor observes a different behavior of the observed module than behaviors observed by the plurality of observer modules.

29. The processor of claim 27, wherein means for aggregating classifications of behaviors of the observed module determined by the processor and each of a plurality of observer modules comprises means for weighting classifications from the processor and each of the observer modules based on a perspective of the processor and each observer module on the behaviors of the observed module.

30. The computing device of claim 29, wherein the perspective of the processor and each observer module on the behaviors of the observed module comprises one or more of a number of behaviors of the observed module observed by the processor and each of the observer modules, one or more types of behaviors of the observed module observed by the processor and each of the observer modules, a duration of observation of the behavior of the observed module by the processor and each of the observer modules, and a complexity of observation of the behavior of the observed module by the processor and each of the observer modules.
